(19) United States
(12) Patent Application Publication
(10) Pub. No.: US 2026/0009407 A1
(43) Pub. Date: Jan. 8, 2026

(54) ACCUMULATOR COVER, METHOD OF MANUFACTURING ACCUMULATOR COVER, AND ACCUMULATOR FOR ANTI-LOCK BRAKE SYSTEM

(71) Applicant: HYUNDAI MOBIS CO., LTD., Seoul (KR)

(72) Inventor: Sung Ki AHN, Yongin-si (KR)

(73) Assignee: HYUNDAI MOBIS CO., LTD., Seoul (KR)

(21) Appl. No.: 19/089,306

(22) Filed: Mar. 25, 2025

(30) Foreign Application Priority Data
Jul. 8, 2024 (KR) 10-2024-0089648

(51) Int. Cl. F15B 1/24

(52) U.S. Cl. CPC F15B 1/24; F15B 2201/4053

(57) ABSTRACT

An accumulator cover for an accumulator for an anti-lock brake system includes a porous body part that closes one open side of a cylindrical space of the accumulator and includes a plurality of micropores through which gas passes, wherein a piston is installed to be reciprocally movable in the cylindrical space. The accumulator cover also includes a body coupling part connected to the porous body part and coupled to a body of the accumulator in which the cylindrical space is disposed. A method for manufacturing the accumulator cover is also provided.

### CROSS-REFERENCE TO RELATED APPLICATIONS

This application claims priority from and the benefit under 35 USC § 119 of Korean Patent Application No. 10-2024-0089648, filed on Jul. 8, 2024, in the Korean Intellectual Property Office, the entire disclosure of which is incorporated by reference for all purposes.

### TECHNICAL FIELD

Exemplary embodiments of the present disclosure relate to an accumulator cover, a method of manufacturing an accumulator cover, and an accumulator for an anti-lock brake system, and more particularly, to an accumulator cover with micropores, a method of manufacturing the accumulator cover, and an accumulator for an anti-lock brake system including the accumulator cover.

### BACKGROUND

An anti-lock brake system (hereinafter, referred to as “ABS”) installed in a vehicle is a device that prevents wheels from slipping on a road surface by interrupting a braking hydraulic pressure transmitted to the wheels of the vehicle to ensure safe braking of the vehicle. An accumulator for the anti-lock brake system may be installed in a hydraulic block of a braking device for a vehicle.

The accumulator for the anti-lock brake system includes a piston that reciprocates by the hydraulic pressure of brake fluid. However, there is a problem in that the piston does not reciprocate quickly and is delayed in response to changes in the hydraulic pressure.

The background technology of the present disclosure is disclosed in Korean Patent Publication No. 10-2005-0046417 (published on May 18, 2005, and entitled “Hydraulic unit for anti-lock brake system and method of manufacturing the same”).

### SUMMARY

An object of the present disclosure is to provide an accumulator cover that allows gas to pass through but blocks foreign substances, a method of manufacturing the accumulator cover, and an accumulator for an anti-lock brake system including the accumulator cover.

In an embodiment of the present disclosure, an accumulator cover may include a porous body part that closes one open side of a cylindrical space and includes a plurality of micropores through which gas passes, wherein a piston is installed to be reciprocally movable in the cylindrical space, and a body coupling part connected to the porous body part and coupled to a body in which the cylindrical space is disposed.

A surface of the porous body part may include a pore-exposed surface where the micropores are exposed and a pore-closed surface where the micropores are closed.

A magnitude of surface roughness of the pore-exposed surface may be larger than a magnitude of surface roughness of the pore-closed surface.

The plurality of micropores may be formed in the accumulator cover by sintering metal powder such that liquid does not pass through the plurality of micropores.

The accumulator cover may include a sintered metal material.

An inner surface of the porous body part facing the piston may be concave, an outer surface of the porous body part opposite to the inner surface may be convexly protruded, and the body coupling part may extend in a radial direction from the porous body part.

The accumulator cover may have the pore-closed surface on only one of the inner surface and the outer surface.

In an embodiment of the present disclosure, a method of manufacturing an accumulator cover may include a pressurized molding operation of lumping metal powders into a shape of an accumulator cover including a porous body part and a body coupling part connected to the porous body part, and a sintering operation of heating the metal powders lumped into the shape of the accumulator cover and sintering the metal powders into the accumulator cover including the plurality of micropores through which gas passes, in the porous body part.

The metal powder comprises stainless steel powder.

The method of manufacturing an accumulator cover may further include a machining operation of machining a surface of the porous body part such that a pore-closed surface where the micropores are closed is formed in a portion of the surface of the porous body part after the sintering operation.

The machining operation may include a turning operation of holding the sintered accumulator cover with a chuck and rotating the sintered accumulator while bringing a tool into contact with the surface to finely cut the surface.

In the sintering operation, the accumulator cover may be sintered such that the body coupling part includes a plurality of micropores, and the machining operation may include an operation of machining a surface of the body coupling part such that the micropores of the body coupling part are closed.

In an embodiment of the present disclosure, an accumulator for an anti-lock brake system may include a body including a cylindrical space with one side open and the other side connected to a hydraulic line, a piston installed inside the cylindrical space to be reciprocally movable in a longitudinal direction of the cylindrical space, a spring that elastically presses the piston such that the piston faces the other side of the cylindrical space, and an accumulator cover including a porous body part that closes the one side of the cylindrical space and includes a plurality of micropores through which gas passes and a body coupling part connected to the porous body part and coupled to the body.

One end of the spring may be supported by the accumulator cover, and the other end of the spring may support the piston.

The piston may include an annular groove on an outer surface, and the accumulator for an anti-lock brake system may further include an annular sealing member installed in the annular groove.

According to the present disclosure, because air passes through the accumulator cover, when the piston reciprocates in the cylindrical space of a body, the air pressure in the space between the piston and the accumulator cover can be maintained equal to the atmospheric pressure. Accordingly, the piston can reciprocate quickly in response to rapid changes in hydraulic pressure in a hydraulic line, so that the operational reliability of the anti-lock brake system can be improved.

According to the present disclosure, foreign substances in liquid and solid forms cannot penetrate into the cylindrical space of the body through the accumulator cover. Accordingly, the durability of the accumulator for an anti-lock brake system and the brake device for a vehicle including the same can be improved.

### BRIEF DESCRIPTION OF THE DRAWINGS

FIG. 1 is a cross-sectional view illustrating an accumulator for an anti-lock brake system according to an embodiment of the present disclosure, illustrating a state in which a piston is positioned at a top dead center.

FIG. 2 is a cross-sectional view illustrating an accumulator for an anti-lock brake system according to an embodiment of the present disclosure, illustrating a state in which a piston is positioned at a bottom dead center.

FIG. 3 is an enlarged view of portion “A” of FIG. 1.

FIG. 4 is a perspective view illustrating an accumulator cover according to an embodiment of the present disclosure, viewed from below.

FIG. 5 is a plan view illustrating the accumulator cover of FIG. 4.

FIG. 6 is a graph illustrating an effect of an accumulator for an anti-lock brake system according to an embodiment of the present disclosure.

FIG. 7 is a block diagram illustrating a method of manufacturing an accumulator cover according to an embodiment of the present disclosure.

FIG. 8 is a perspective view illustrating an accumulator cover according to another embodiment of the present disclosure, viewed from below.

### DETAILED DESCRIPTION

Hereinafter, an accumulator cover, a method of manufacturing an accumulator cover, and an accumulator for an anti-lock brake system will be described below in more detail with reference to the accompanying drawings through various exemplary embodiments. The terms used herein are terms defined in consideration of functions of the present disclosure, and these terms may change depending on the intention or practice of a user or an operator. Therefore, these terms should be defined based on the entirety of the disclosure set forth herein.

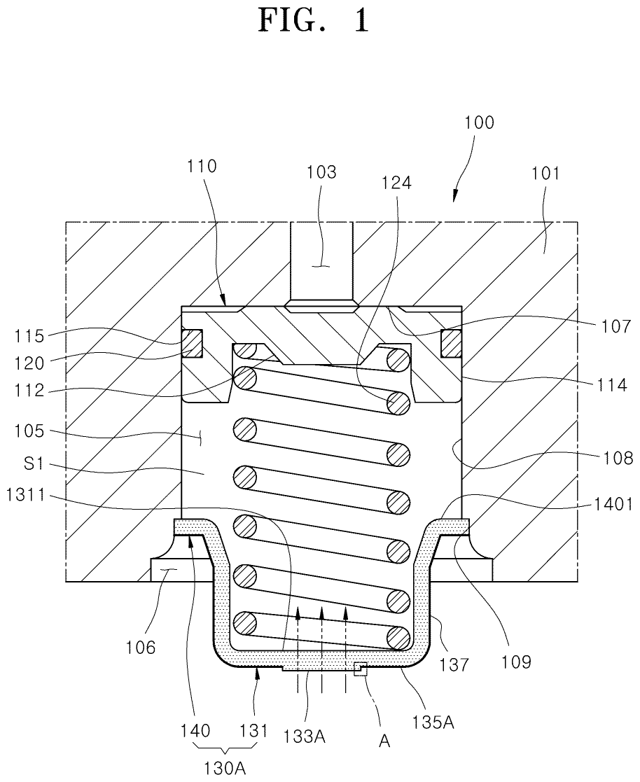

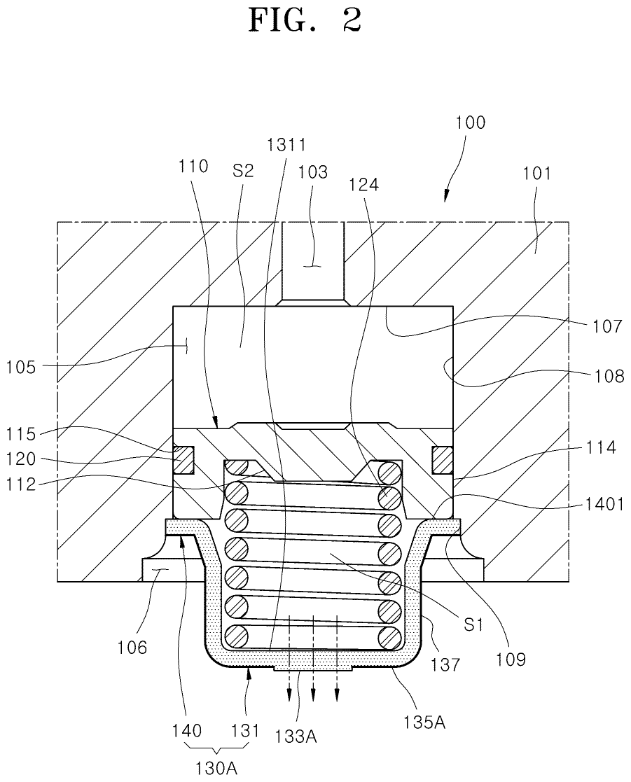

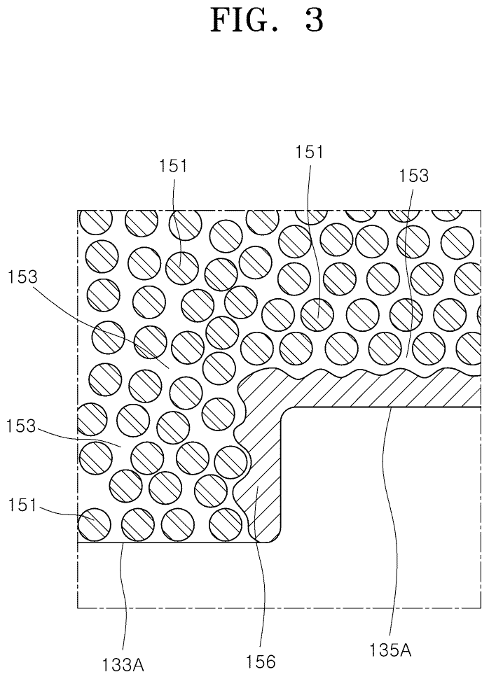

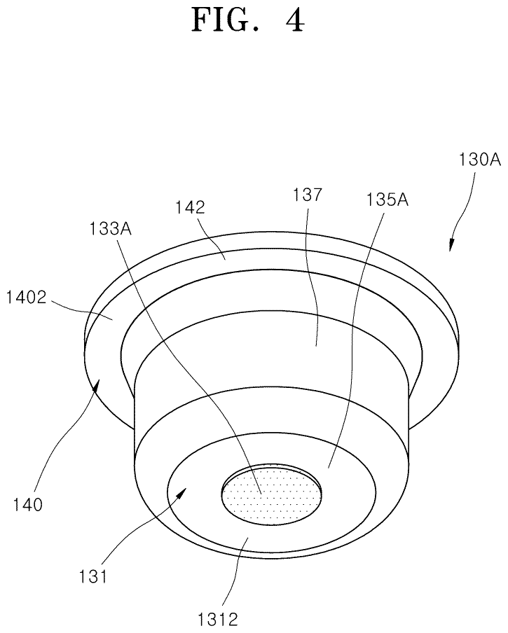

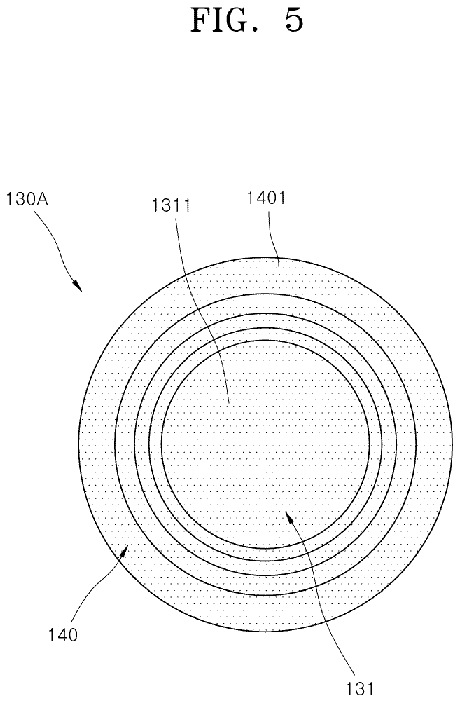

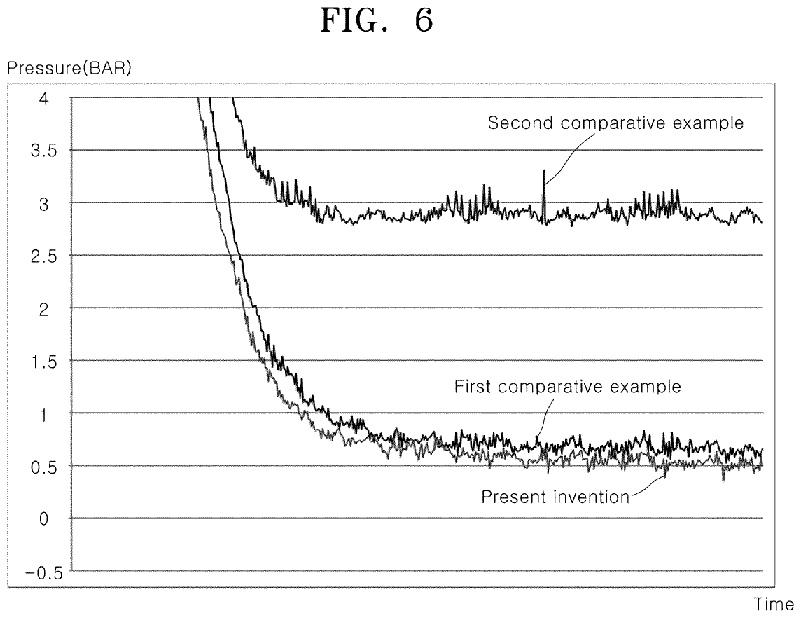

FIG. 1 is a cross-sectional view illustrating an accumulator for an anti-lock brake system according to an embodiment of the present disclosure, illustrating a state in which a piston is positioned at a top dead center. FIG. 2 is a cross-sectional view illustrating an accumulator for an anti-lock brake system according to an embodiment of the present disclosure, illustrating a state in which a piston is positioned at a bottom dead center. FIG. 3 is an enlarged view of portion “A” of FIG. 1. FIG. 4 is a perspective view illustrating an accumulator cover according to an embodiment of the present disclosure, viewed from below. FIG. 5 is a plan view illustrating the accumulator cover of FIG. 4. FIG. 6 is a graph illustrating an effect of an accumulator for an anti-lock brake system according to an embodiment of the present disclosure.

Referring to FIGS. 1 to 5, the accumulator for an anti-lock brake system 100 according to an embodiment of the present disclosure (hereinafter, referred to as “accumulator”) is a device that allows brake fluid to be quickly supplied and temporarily stored when the anti-lock brake system operates. In an internal combustion engine vehicle, the anti-lock brake system operates when a driver presses a brake pedal, but in an electric vehicle, the anti-lock brake system can operate even when the driver does not press the brake pedal and regenerative braking is generated when an accelerator pedal is not pressed.

The accumulator 100 includes a body 101, a piston 110, a spring 124, and an accumulator cover 130A. A cylindrical space 105 is provided in the body 101 with one side open and the other side connected to a hydraulic line 103. The body 101 may be a hydraulic block of a brake device for a vehicle. The hydraulic line 103 filled with brake fluid may be disposed in the hydraulic block to transmit hydraulic pressure.

The cylindrical space 105 may be opened to one side of the body 101 through an opening 106 formed on one side of the body 101. The cylindrical space 105 may be defined by a cylinder end surface 107 provided opposite the opening 106 and a cylinder inner surface 108 having a circular cross-sectional shape. The hydraulic line 103 is fluidly connected to the cylinder end surface 107.

The piston 110 is installed inside the cylindrical space 105 to be reciprocally movable in the longitudinal direction of the cylindrical space 105. An outer surface 114 of the piston 110 may face the cylinder inner surface 108. The cross-sectional shape of the piston 110 may be circular to correspond to the cross-sectional shape of the cylinder inner surface 108.

The piston 110 may include an annular groove 115 on the outer surface 114. The accumulator 100 may further include an annular sealing member 120 disposed in the annular groove 115. The sealing member 120 may be, for example, an O-ring. The leakage of fluid, such as brake fluid or air, between the cylinder inner surface 108 and the outer surface 114 of the piston 110 can be prevented by the sealing member 120.

The spring 124 elastically presses the piston 110 toward the other side of the cylindrical space 105. The other side of the cylindrical space 105 may mean the opposite side of the one side where the opening 106 is formed. For example, the spring 124 may elastically press the piston 110 toward the cylinder end surface 107. The spring 124 may be a coil spring.

The accumulator cover 130A includes a porous body part 131 that closes one side of the cylindrical space 105 and a body coupling part 140 that is connected to the porous body part 131 and coupled to the body 101. The porous body part 131 may close the opening 106 of the cylindrical space 105.

An inner surface 1311 of the porous body part 131 facing the piston 110 with the spring 124 in between may be concave, and an outer surface 1312 of the porous body part 131, which is opposite to the inner surface 1311, may be convexly protruded. For example, the shape of the porous body part 131 may be a cup shape.

The body coupling part 140 may extend radially from the porous body part 131. For example, the body coupling part 140 may have an annular shape. The body 101 has an annular groove 109 that is stepped on the inner surface defining the opening 106, and an outer peripheral end of the body coupling part 140 may be fitted into the annular groove 109 so that the body coupling part 140 may be coupled to the body 101.

The cylindrical space 105 may be divided into a first space S1 between the accumulator cover 130A and the piston 110 and a second space S2 between the piston 110 and the cylinder end surface 107.

One end of the spring 124 may be supported by the accumulator cover 130A, and the other end of the spring 124 may support the piston 110. For example, one end of the spring 124 may be fitted to the inner surface 1311 of the concave porous body part 131 without being detached. The other end of the spring 124 can be fitted to the inner surface 112 of the concave piston 110 not to be detached.

The porous body part 131 includes a plurality of micropores 153 through which gas passes. A surface of the porous body part 131 may include a pore-exposed surface 133A where the micropores 153 are exposed and pore-closed surfaces 135A and 137 where the micropores 153 are closed.

The pore-closed surfaces 135A and 137 of the porous body part 131 may be divided into a first pore-closed surface 135A and a second pore-closed surface 137. The pore-exposed surface 133A is formed in a circular shape, and the first pore-closed surface 135A is formed in an annular shape surrounding the outside of the pore-exposed surface 133A. The second pore-closed surface 137 may be connected to be folded outside the first pore-closed surface 135A.

The surface of the body coupling part 140 may also include a pore-closed surface 142 with closed micropores 153. The pore-closed surface 142 of the body coupling part 140 may be connected to be folded outside the second pore-closed surface 137.

The porous body part 131 may have the pore-closed surfaces 135A and 137 only on the outer surface 1312 among the convex outer surface 1312 and the concave inner surface 1311, and may not have a pore-closed surface on the inner surface 1311. The body coupling part 140 may have the pore-closed surface 142 only on the outer surface of the body coupling part 140 opposite to the piston 110, and may not have the pore-closed surface on the inner surface 1401 of the body coupling part 140 facing the piston 110.

Through the pore-exposed surface 133A, gas such as air may pass through the accumulator cover 130A. For example, as shown in FIG. 1, in a state in which the piston 110 is positioned at the top dead center in the cylindrical space 105 and the first space S1 is minimized, when brake fluid is introduced into the cylindrical space 105 through the hydraulic line 103 such that a wheel cylinder (not shown) of the vehicle wheel (not shown) is depressurized, the first space S1 is expanded and the second space S2 is reduced, as shown in FIG. 2.

As the second space S2 is reduced, the air passes through the accumulator cover 130A via the pore-exposed surface 133A and is released to the outside of the body 101, and the air pressure of the second space S2 may be maintained at the atmospheric pressure.

In addition, as shown in FIG. 2, in a state in which the piston 110 is positioned at the bottom dead center in the cylindrical space 105 and the first space S1 is maximized, when the brake fluid flows out of the cylindrical space 105 through the hydraulic line 103 from the first space S1 to the outside of the cylindrical space 105 such that the wheel cylinder of the vehicle wheel is pressurized, the second space S1 is expanded and the first space S2 is reduced, as shown in FIG. 1.

As the second space S2 is expanded, air passes through the accumulator cover 130A through the pore-exposed surface 133A and flows into the second space S2 from the outside of the body 101, and the pressure of the second space S2 may be maintained at atmospheric pressure. Accordingly, the piston 110 can reciprocate quickly in response to rapid changes in hydraulic pressure in the hydraulic line 103, thereby improving the operational reliability of the anti-lock brake system.

Liquids and solids cannot pass through the micropores 153. Therefore, liquid or solid contaminants such as water (H2O), dust, and foreign substances cannot penetrate from the outside of the body 101 into the cylindrical space 105. Accordingly, the breakdown or malfunction of the accumulator 100 due to contamination or corrosion can be prevented, and the durability of the accumulator for the anti-lock brake system and the vehicle brake device including the same can be improved.

The magnitude of the surface roughness of the pore-exposed surface 133A may be larger than the magnitude of the surface roughness of each of the pore-closed surfaces 135A, 137, and 142. The accumulator cover 130A may include a sintered metal material.

Referring to FIGS. 1, 2, and 6, the change in air pressure in the second space S2 over time is shown in FIG. 6 when brake fluid flows into the first space S1 through the hydraulic line 103 and the piston 110 moves from the top dead center to the bottom dead center such that the state of the wheel cylinder of the vehicle wheel changes from a pressurized stable state to a depressurized state.

In FIG. 6, a blue solid line graph represents the test results of an accumulator 100 according to an embodiment of the present disclosure illustrated in FIGS. 1 and 2, that is, the accumulator including the accumulator cover 130A having the pore-exposed surface 133A (hereinafter, referred to as “the present disclosure”). A red solid line graph represents the test results of an accumulator including an accumulator cover having a through hole formed in a thickness direction (hereinafter, referred to as “first comparative example”). A black solid line graph represents the test results of an accumulator including an accumulator cover without a pore-exposed surface and no through holes (hereinafter, referred to as “second comparative example”).

In a case of the second comparative example, it can be seen that the air pressure of the second space S2 is much greater than the atmospheric pressure and the second space S2 is compressed by high pressure. In the case of each of the present disclosure and the first comparative example, it can be seen that the air pressure of the second space S2 is similar to the atmospheric pressure. Meanwhile, as described above, the present disclosure prevents foreign substances in liquid and solid states from penetrating into the accumulator 100 through the accumulator cover 130A, but in the case of the first comparative example, foreign substances in liquid and solid states can penetrate into the accumulator.

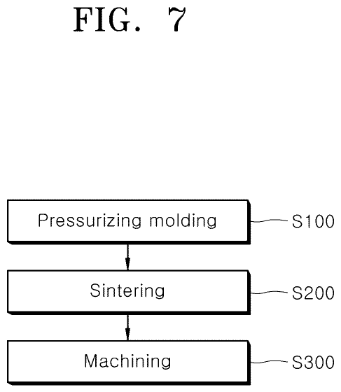

FIG. 7 is a block diagram illustrating a method of manufacturing an accumulator cover according to an embodiment of the present disclosure. Referring to FIGS. 1, 3 to 5, and 7, the method of manufacturing the accumulator cover 130A according to an embodiment of the present disclosure may include a pressurizing molding operation S100 and a sintering operation S200.

The pressurizing molding operation (S100) is an operation of forming metal powders 151 into a shape of the accumulator cover 130A including the porous body part 131 and the body coupling part 140. In this operation, a plurality of metal powders 151 may be pressurized such that the gap between adjacent metal powders 151 does not become excessively large and the plurality of metal powders 151 do not scatter. The metal powder 151 may include, for example, stainless steel powder.

The sintering operation S200 is an operation of heating the plurality of metal powders 151 lumped together in the shape of the accumulator cover 130A to sinter the metal powders 151 into the accumulator cover 130A including the plurality of micropores 153 through which gas passes, to the porous body 131.

In the sintering operation S200, the metal powders 151 may be heated to a temperature at which the metal powders 151 are not completely melted, thereby solidifying the metal powders 151 into the shape of the accumulator cover 130A. Through the sintering operation S200, not only the porous body part 131 but also the body coupling part 140 may include the plurality of microscopic pores 153.

The method of manufacturing the accumulator cover 130A may further include a machining operation S300. The machining operation S300 is an operation of machining a surface of the porous body part 131 after the sintering operation S200 such that the pore-closed surfaces 135A and 137 with closed micropores 153 are formed in some portions of the surface of the porous body part 131.

As described above, the body coupling part 140 may also include the plurality of micropores 153 through the sintering operation S200. Therefore, the machining operation S300 may include an operation of machining the surface of the body coupling part 140 such that the pore-closed surface 142 with the closed micropores 153 is formed in the surface of the body coupling part 140.

The machining operation S300 may include a turning operation of finely cutting the surface of the porous body part 131 or the surface of the body coupling part 140 by contacting a tool (not shown) with the surface of the porous body part 131 or the surface of the body coupling part 140 while holding and rotating the sintered accumulator cover 130A with a chuck (not shown). However, the turning operation is only an example, and other types of machining, such as milling, may also be applied.

As the surface of the porous body part 131 is cut, a processed modification layer 156 may be formed in which the closed micropores 153 are exposed to the surface. The outermost surface of the processed modification layer 156 may become the pore-closed surface 135A. Although not shown, even when the surface of the body coupling part 140 is cut, a processed modification layer may be formed similarly to the processed modification layer 156 of the porous body part 131.

The inner surface 1311 of the porous body part 131 and the inner surface 1401 of the body coupling part 140 may not be machined. In this case, as shown in FIG. 5, the micropores may be exposed to the inner surface 1311 of the porous body part 131 and the inner surface 1401 of the body coupling part 140.

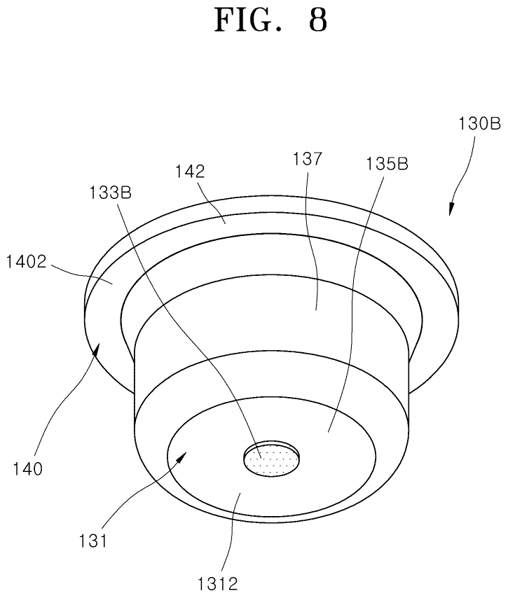

FIG. 8 is a perspective view illustrating an accumulator cover according to another embodiment of the present disclosure, viewed from below. Referring to FIG. 8, the accumulator cover 130B according to another embodiment of the present disclosure may be included in the accumulator 100 of FIGS. 1 and 2 in place of the accumulator cover 130A shown in FIG. 4.

The accumulator cover 130B may include a porous body part 131 and a body coupling part 140. The porous body part 131 and the body coupling part 140 are indicated by the same reference numerals as the porous body part 131 and the body coupling part 140 of the accumulator 130A according to an embodiment of the present disclosure and have the same characteristics, and thus, a duplicate description is omitted.

The porous body part 131 includes a plurality of micropores 153 through which gas passes. The surface of the porous body part 131 may include a pore-exposed surface 133B where the micropores 153 are exposed and pore-closed surfaces 135B and 137 where the micropores 153 are closed.

The pore-closed surfaces 135B and 137 of the porous body part 131 may be divided into a first pore-closed surface 135B and a second pore-closed surface 137. The pore-exposed surface 133B may be formed in a circular shape, and the first pore-closed surface 135B may be formed in an annular shape surrounding the outside of the pore-exposed surface 133B. The second pore-closed surface 137 may be connected to be folded from the outside of the first pore-closed surface 135B.

The surface of the body coupling part 140 may also include a pore-closed surface 142 with closed micropores 153. The pore-closed surface 142 of the body coupling part 140 may be connected to be folded outside the second pore-closed surface 137.

The diameter and area of the pore-exposed surface 133B of the accumulator cover 130B shown in FIG. 8 may be smaller than the diameter and area of the pore-exposed surface 133A of the accumulator cover 130A shown in FIG. 4. When the surface of the porous body part 131 is cut more using a tool in the machining operation S300 described with reference to FIG. 7, it is possible to manufacture the accumulator cover 130B with smaller diameter and area of the pore-exposed surface 133B and larger area of the first pore-closed surface 135B, compared to the case of FIG. 4, As shown in FIG. 8.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An accumulator cover for an accumulator, comprising:
a porous body part that closes an open side of a cylindrical space in a body of the accumulator, wherein the porous body part includes a plurality of micropores configured in the porous body part so that gas passes through the micropores, wherein a piston is installed to be reciprocally movable in the cylindrical space; and
a body coupling part connected to the porous body part and coupled to the body of the accumulator in which the cylindrical space is disposed.

2. The accumulator cover of claim 1, wherein a surface of the porous body part comprises a pore-exposed surface where the micropores are exposed and a pore-closed surface where the micropores are closed.

3. The accumulator cover of claim 2, wherein a magnitude of surface roughness of the pore-exposed surface is larger than a magnitude of surface roughness of the pore-closed surface.

4. The accumulator cover of claim 1, wherein the plurality of micropores are formed in the accumulator cover by sintering metal powder such that liquid is prevented from passing through the plurality of micropores.

5. The accumulator cover of claim 1, wherein the micropores are configured in the porous body part so that liquid is prevented from passing through the porous body part.

6. The accumulator cover of claim 2, wherein a layer of non-porous material is formed over the surface of the porous body part to form the pore-closed surface.

7. A method of manufacturing an accumulator cover for an accumulator, the method comprising:
a pressurized molding operation of lumping metal powders into a shape of an accumulator cover including a porous body part and a body coupling part connected to the porous body part and configured to be coupled to a body of the accumulator; and
a sintering operation of heating the metal powders lumped into the shape of the accumulator cover and sintering the metal powders into the accumulator cover to include a plurality of micropores configured in the porous body part so that gas passes through the micropores in the porous body part.

8. The method of claim 7, wherein the metal powder comprises stainless steel powder.

9. The method of claim 7, further comprising a machining operation of machining a surface of the porous body part such that a pore-closed surface where the micropores are closed is formed in a portion of the surface of the porous body part after the sintering operation.

10. The method of claim 9, further comprising forming a layer of non-porous material over the surface of the porous body part after the machining operation to form the pore-closed surface.

11. The method of claim 7, wherein the micropores are configured in the porous body part so that liquid is prevented from passing through the porous body part.

12. An accumulator for an anti-lock brake system, the accumulator comprising:
a body including a cylindrical space with a first side open and a second side connected to a hydraulic line;
a piston installed inside the cylindrical space to be reciprocally movable in a longitudinal direction of the cylindrical space;
a spring that elastically presses the piston such that the piston faces the second side of the cylindrical space; and
an accumulator cover including a porous body part that closes the first side of the cylindrical space and includes a plurality of micropores configured in the porous body part so that gas passes through the micropores, the accumulator cover further including a body coupling part connected to the porous body part and coupled to the body of the accumulator.

13. The accumulator of claim 12, wherein one end of the spring is supported by the accumulator cover, and another end of the spring supports the piston.

14. The accumulator of claim 12,
wherein the piston includes an annular groove on an outer surface of the piston, and
wherein the accumulator for an anti-lock brake system further comprises an annular sealing member installed in the annular groove.

15. The accumulator of claim 12, wherein the micropores are configured in the porous body part so that liquid is prevented from passing through the porous body part.

16. The accumulator cover of claim 12, wherein a surface of the porous body part comprises a pore-exposed surface where the micropores are exposed and a pore-closed surface where the micropores are closed.

17. The accumulator of claim 16, wherein a layer of non-porous material is formed over the surface of the porous body part to form the pore-closed surface.
